(19) United States
(12) Patent Application Publication
(10) Pub. No.: US 2020/0238948 A1
(43) Pub. Date: Jul. 30, 2020

(54) SEATBELT ASSEMBLIES HAVING AIR DAMPERS FOR REMOVING SLACK FROM A TETHER OF A SEATBELT BUCKLE

(71) Applicant: Toyota Motor Engineering & Manufacturing North America, Inc., Plano, TX (US)

(72) Inventor: Colby S. Williams, Ann Arbor, MI (US)

(73) Assignee: Toyota Motor Engineering & Manufacturing North America, Inc., Plano, TX (US)

(21) Appl. No.: 16/262,119

(22) Filed: Jan. 30, 2019

(51) Int. Cl. B60R 22/28; F16F 13/00

(52) U.S. Cl. CPC B60R 22/28; F16F 13/007; B60R 2022/281; F16F 2236/045; F16F 2222/126; F16F 2228/14; F16F 2232/08; B60R 2022/282

(57) ABSTRACT

A seatbelt assembly includes a seatbelt buckle and an air damper. The seatbelt buckle is coupled to an anchor point. The air damper is disposed between and coupled to the seat belt buckle and the anchor point. The air damper is configured to increase a resistance force applied to counteract movement of the seatbelt buckle away from the air damper as a speed of the movement of the seatbelt buckle increases.

### TECHNICAL FIELD

The present specification generally relates to seatbelt assemblies and, more specifically, to seatbelt assemblies having air dampers configured to remove slack from a seatbelt buckle tether.

### BACKGROUND

It has been known to provide vehicles with seatbelt assemblies that include a seatbelt buckle and a tether having one end attached to the seatbelt buckle and an opposite end attached to an anchor point. The previously known seatbelt assemblies are provided with additional slack in the tether to allow a user to move the seatbelt buckle to aid in the positioning of the seatbelt buckle during buckling. However, when the seatbelt buckle is in an unbuckled state, the additional slack in the tether may position the seatbelt buckle in an undesirable position on the seat assembly, such that a user is required to move the seatbelt buckle prior to avoid sitting on the seatbelt buckle.

Accordingly, there is a need for seatbelt assemblies that remove additional slack of a tether connected to a seatbelt buckle in a buckled state or an unbuckled state and which allow for an increase in slack of the tether to facilitate positioning of the seatbelt buckle during buckling.

### SUMMARY

In one embodiment, a seatbelt assembly includes a seatbelt buckle and an air damper. The seatbelt buckle is coupled to an anchor point. The air damper is disposed between and coupled to the seat belt buckle and the anchor point. The air damper is configured to increase a resistance force applied to counteract movement of the seatbelt buckle away from the air damper as a speed of the movement of the seatbelt buckle increases.

In some embodiments, the air damper of the seatbelt assembly may include a housing, a piston, and a biasing member. The housing includes a side wall, a proximate end wall, and a distal end wall that defines a chamber. The piston is disposed within the chamber. The biasing member is disposed within the chamber between the distal end wall and the piston. The distal end wall defines a through-bore. The piston is movable between an initial position and a displaced position. The biasing member biases the piston towards the initial position. The seatbelt buckle is coupled to the air damper by a tether having a buckled end connected to the seatbelt buckle and a damper end connected to the piston.

In some embodiments, the seatbelt buckle may be moveable between a retracted position and an extended position. The piston is moved from the initial position towards the displaced position upon movement of the seatbelt buckle from the retracted position towards the extended position.

In some embodiments, a portion of the tether extends through the through-bore formed in the distal end wall.

In some embodiments, a gap is formed between an outer surface of the tether and an inner surface of the through-bore.

In some embodiments, upon movement of the seatbelt buckle from the retracted position towards the extended position, the piston is moved from the initial position towards the displaced position due to the connection of the seatbelt buckle and the piston by the tether.

In some embodiments, upon movement of the seatbelt buckle from the retracted position towards the extended position, the piston is moved from the initial position towards the displaced position such that the resistance force is applied to counteract movement of the seatbelt buckle from the retracted position towards the extended position due to an amount of air that passes through the gap in the distal end wall due to the movement of the piston.

In some embodiments, the resistance force applied to counteract movement of the seatbelt buckle away from the air damper is larger when the speed of the movement of the seatbelt buckle from the retracted position towards the extended position is high compared to the resistance force applied to counteract movement of the seatbelt buckle away from the air damper when the speed of the movement of the seatbelt buckle from the retracted position towards the extended position is low.

In some embodiments, upon completion of movement of the seatbelt buckle away from the air damper, the biasing spring biases the piston from the displaced position towards the initial position.

In some embodiments, the biasing member is a spring, and the portion of the tether within the chamber extends coaxially with the spring.

Additional features of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a perspective view of a seatbelt assembly according to one or more embodiments shown or described herein;

FIG. 2 schematically depicts a partial cross-sectional view of the seatbelt assembly of FIG. 1 in which a seatbelt buckle is in a retracted position, according to one or more embodiments shown or described herein;

FIG. 3 schematically depicts a partial cross-sectional view of the seatbelt assembly of FIG. 1 in which the seatbelt buckle is in an extended position, according to one or more embodiments shown or described herein;

FIG. 4 schematically depicts a partial front view of an air damper and a tether of the seatbelt assembly of FIG. 1, according to one or more embodiments shown or described herein; and

FIG. 5 schematically depicts a partial cross-sectional view of a seatbelt assembly according to one or more embodiments shown or described herein.

### DETAILED DESCRIPTION

Seatbelt assemblies according to the present specification include a seatbelt buckle and an air damper. The seatbelt buckle is coupled to an anchor point. The air damper is disposed between and coupled to the seatbelt buckle and the anchor point. The air damper is configured to increase a resistance force applied to counteract movement of the seatbelt buckle away from the air damper as a speed of the movement of the seatbelt buckle increases.

Various embodiments of a seatbelt assembly having an air damper and for operating the same will be described herein with specific reference to the appended drawings.

As used herein, the term “vehicle longitudinal direction” refers to the forward-rearward direction of the vehicle (i.e., in the +/−vehicle X-direction as depicted). The term “vehicle lateral direction” refers to the cross-vehicle direction of the vehicle (i.e., in the +/−vehicle Z-direction as depicted), and is transverse to the vehicle longitudinal direction. The term “vehicle vertical direction” refers to the upward-downward direction of the vehicle (i.e., in the +/−vehicle Y-direction as depicted). As used herein, “upper” and “above” are defined as the positive Y direction of the coordinate axis shown in the drawings. “Lower” and “below” are defined as the negative Y direction of the coordinate axis shown in the drawings. Further, the terms “outboard” as used herein refers to the relative location of a component with respect to a vehicle centerline. The term “inboard” as used herein refers to the relative location of a component with respect to the vehicle centerline. Because the vehicle structures may be generally symmetrical about the vehicle centerline, the direction to which use of terms “inboard” or “outboard” and refer may be mirrored about the vehicle centerline when evaluating components positioned along opposite sides.

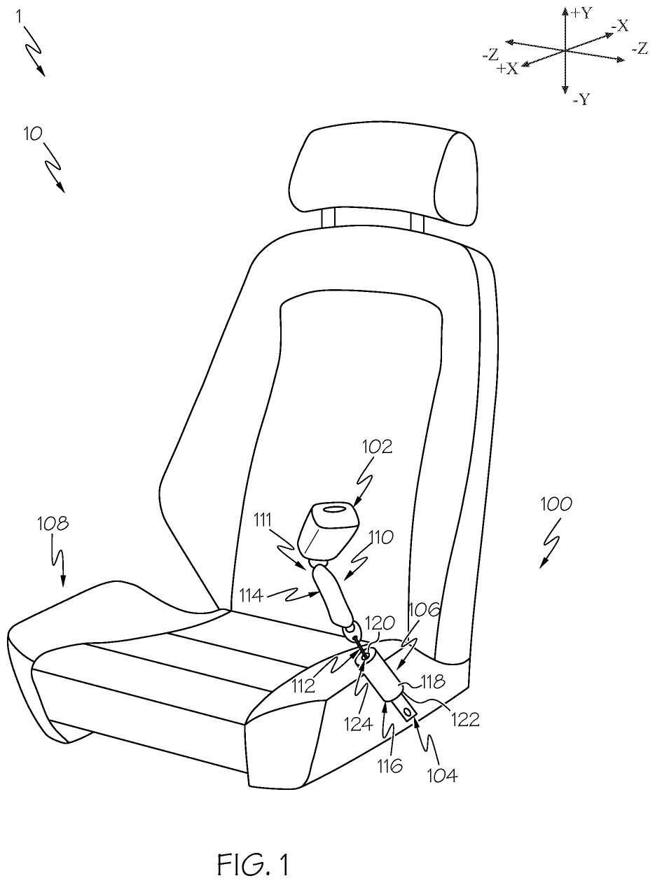

Referring now to FIG. 1, a seat assembly 10 is generally depicted. In some embodiments, the seat assembly 10 is provided within a vehicle 1. In some embodiments, the vehicle 1 is a car. In some other embodiments, the vehicle 1 may be a truck, a sport utility vehicle, a van, a boat, a plane, or other vehicle types.

The seat assembly 10 includes a seatbelt assembly 100. The seatbelt assembly 100 is provided for retaining an occupant to be supported on the seat assembly 10. The seatbelt assembly 100 includes a seatbelt buckle 102 coupled to an anchor point 104, and an air damper 106 disposed between and coupled to the seatbelt buckle 102 and the anchor point 104. In some embodiments, anchor point 104 may be secured to either a seat 108 of the seat assembly 10 or a seat frame (not shown) which the seat 108 is mounted. In some other embodiments, the anchor point 104 is mounted to a vehicle body component directly or indirectly. The seatbelt buckle 102 engages with a seatbelt tongue plate that is connected to a seatbelt webbing such that upon connection between the seatbelt tongue plate and the seatbelt buckle 102 the occupant is retained within the seat 108.

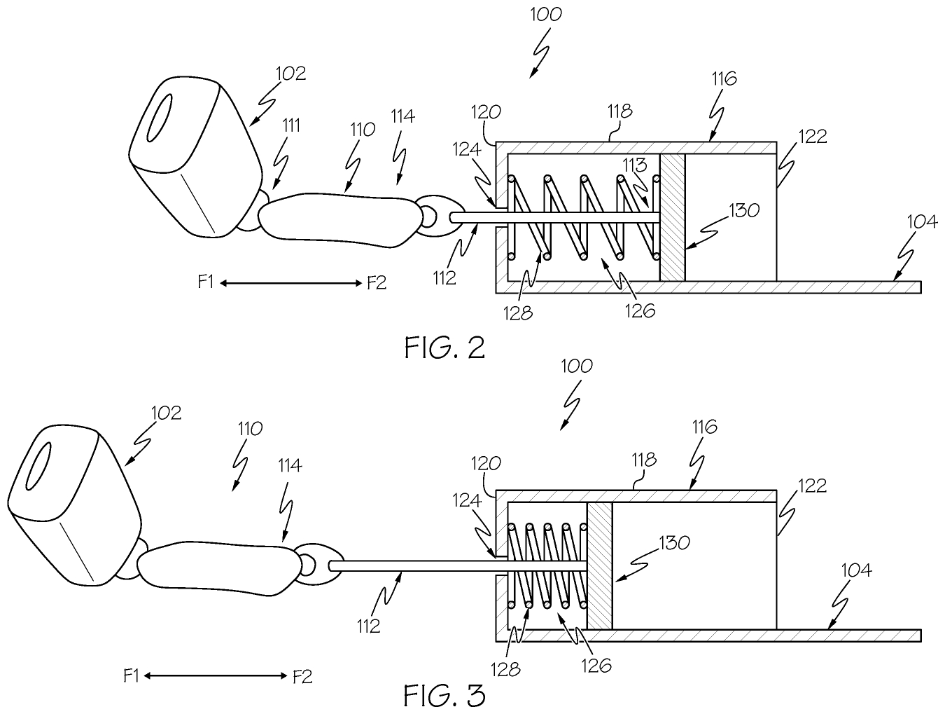

The air damper 106 is configured to increase a resistance force applied to counteract movement of the seatbelt buckle 102 away from the air damper 106 as a speed of the movement of the seatbelt buckle 102 increases. The seatbelt buckle 102 is mounted to the air damper 106 by a tether 110 that includes a cord portion 112 and a tether portion 114. The tether portion 114 is secured to the cord portion 112 by a clasp. In some embodiments, the tether portion 114 and cord portion 112 are formed integrally as a one piece monolithic structure as a single tether. The tether 110 includes a buckle end 111. The buckle end 111 of the tether 110 is an end of the tether portion 114 connected to the seatbelt buckle 102. As shown in FIGS. 2 and 3, the tether 110 includes damper end 113 opposite the buckle end 111. The damper end 113 of the tether 110 is an end of the cord portion 112 connected to the air damper 106, described in greater detail below. In some embodiments, the tether portion 114 is provided as a webbing and the cord portion 112 is provided as a cable and/or cord having a generally circular cross-sectional shape.

The air damper 106 includes a housing 116. The 116 includes a side wall 118, a distal end wall 120, and a proximate end wall 122. Referring to FIGS. 2 and 3, the side wall 118, the distal end wall 120, and the proximate end wall 122 define a chamber 126. A through-bore 124 is positioned in the distal end wall 120 which allows a portion of the cord portion 112 to enter into chamber 126 of air damper 106.

The air damper 106 may include a biasing member 128 and a piston 130. The piston 130 is positioned within the chamber 126 between the distal end wall 120 and the proximate end wall 122. The piston 130 is slidable within the chamber 126 between an initial position, as shown in FIG. 2, and a displaced position, as shown in FIG. 3. In the initial position, a distance between the piston 130 and the distal end wall 120 is larger than a distance between the piston 130 and the distal end wall 120 when in the displaced position. The biasing member 128 is arranged within the chamber 126 between the piston 130 and the distal end wall 120. As stated above, a portion of the cord portion 112 passes into chamber 126 via through-bore 124 and is securely fixed to piston 130. The piston 130 is biased towards the proximate end wall 122 by the biasing member 128. In some embodiments, the biasing member 128 is a spring. The portion of the cord portion 112 that is arranged within chamber 126 extends coaxially with the biasing member 128.

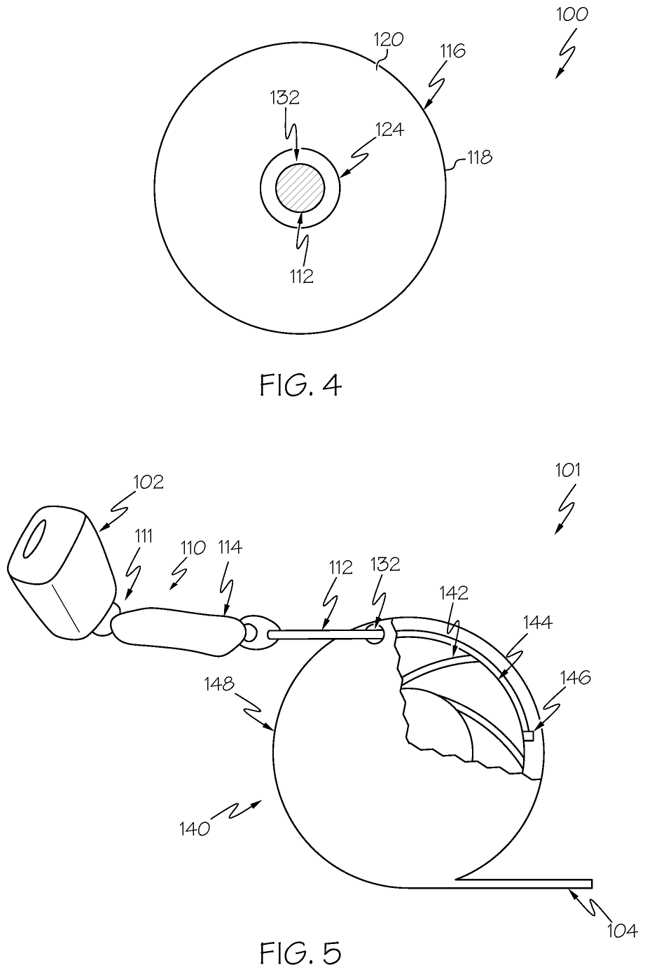

Referring to FIG. 4, the through-bore 124 is formed having an inner diameter that is greater than an outer diameter of the cord portion 112 that extends through the through-bore 124. Specifically, a gap 132 is formed between an outer surface of cord portion 112 and an inner surface of the through-bore 124. The inner diameter of the through-bore 124 is dimensioned so as to be larger than the outer diameter of the cord portion 112 such that the gap 132 is configured to limit an amount of air flow that may pass out of the chamber 126 through the through-bore 124, as will be described in greater detail below.

Referring to FIGS. 2 and 3, the piston 130 is movable between the initial position, as shown in FIG. 2, and the displaced position, as shown in FIG. 3. The seatbelt buckle 102 is moveable between a retracted position, as shown in FIG. 2, and an extended position, as shown in FIG. 3. As shown in FIG. 2, when the seatbelt buckle 102 is in the retracted position, the piston 130 is in the initial position, and as shown in FIG. 3, when the seatbelt buckle 102 is in the extended position, the piston 130 is in the displaced position. As described in greater detail below, the piston 130 is moveable from the initial position towards the displaced position upon movement of the seatbelt buckle 102 from the retracted position towards the extended position, and the seatbelt buckle 102 is moveable from the extended position towards the retracted position upon movement of the piston 130 from the displaced position towards the initial position due to the biasing force of the biasing member 128.

In the retracted position, a distance between the seatbelt buckle 102 and the distal end wall 120 is smaller than a distance between the seatbelt buckle 102 and the distal end wall 120 when the seatbelt buckle 102 is in the extended position. Similarly, a length of the cord portion 112 disposed within the chamber 126 in the retracted position is larger than a length of the cord portion 112 disposed within the chamber 126 in the extended position. In the retracted position, the seatbelt buckle 102 is retracted towards the air damper 106 as the buckle end 111 of the cord portion 112 is attached to the piston 130 and the piston 130 is biased towards the proximate end wall 122. As the length of the cord portion 112 disposed within the chamber 126 is greater in the retracted position compared to the extended position, excess slack of the tether 110 is removed from the seatbelt assembly 100 in the retracted position.

The biasing member 128 biases the piston 130 towards the initial position within the chamber 126. The initial position is also the same position where the air damper 106 is at rest and the biasing member 128 does not push the piston 130 further along the housing 116. As the seatbelt buckle 102 is coupled to the air damper 106, specifically, the damper end 113 of the tether 110 is fixed to the piston 130, the seatbelt buckle 102 is moved into the retracted position upon movement of the piston 130 into the initial position by the biasing force of the biasing member 128.

In order to provide additional distance between the seatbelt buckle 102 and the air damper 106, specifically the distal end wall 120, to allow a user to position the seatbelt buckle 102 during buckling, the seatbelt buckle 102 is moveable from the retracted position towards the extended position upon movement of the seatbelt buckle 102 in the direction of arrow F1 away from the air damper 106. Upon movement of the seatbelt buckle 102 in the direction of arrow F1, that is, from the retracted position towards the extended position, the cord portion 112 applies a force to move the piston 130 from the initial position towards the displaced position. Specifically, the movement of the seatbelt buckle 102 from the retracted position towards the extended position overcomes the biasing force of the biasing member 128 and moves the piston 130 from the initial position towards the displaced position.

As the piston 130 moves from the initial position towards the displaced position, in the direction of arrow F1, air within the chamber 126 between the piston 130 and the distal end wall 120 is displaced and exits the chamber 126 through the gap 132 between the inner surface of the through-bore 124 and the outer surface of the cord portion 112. The air exiting the chamber 126 through the gap 132 between the through-bore 124 and the outer surface of the cord portion 112 creates a resistance force that resists movement of the piston 130 from initial position towards the displaced position in the direction of arrow F1, and consequently the seatbelt buckle 102 from the retracted position towards the extended position. Specifically, due to the size of the gap 132, air that is displaced due to the movement of the piston 130 from the initial position towards the displaced position is inhibited from freely exiting the chamber 126.

As such, the continued movement of the piston 130 from the initial position towards the displaced position increases a pressure within the chamber 126, specifically between the piston 130 and the distal end wall 120. Due to the increase in pressure, the resistance force applied to counteract the movement of the piston 130 from the initial position towards the displaced position, and consequently the movement of the seatbelt buckle 102 from the retracted position towards the extended position, is increased as a speed of the movement of the piston 130, and consequently the speed of the seatbelt buckle 102, is increased. As the speed of movement of the piston 130 increases, the pressure within the chamber 126 between the piston 130 and the distal end wall 120 increases as the displaced air is inhibited from freely flowing out of the gap 132 due to the size of the gap 132. As the pressure within the chamber 126 between the piston 130 and the distal end wall 120 increases the resistance force which counteracts the movement of the piston 130 from the initial position towards the displaced position also increases. As the pressure increase within the chamber 126 between the piston 130 and the distal end wall 120 increases as a speed of the piston 130 from the initial position towards the displaced position, the resistance force which counteracts the movement of the piston 130 from the initial position towards the displaced position increases as a speed of movement of the piston 130 from the initial position towards the displaced position increases.

As the piston 130 is typically moved at a low speed by a user when moving the seatbelt buckle 102 from the retracted position towards the extended position, the resistance force due to the pressure within the chamber 126 is smaller compared to when the piston 130 is moved at a high speed by a body of the user acting upon the seatbelt buckle 102 during a collision or other sudden deceleration.

In some embodiments, upon movement of the seatbelt buckle 102 from the retracted position towards the extended position in the direction of arrow F1, the piston 130 is moved from the initial position towards the displaced position such that the resistance force is applied to counteract movement of the seatbelt buckle 102 from the retracted position towards the extended position in the direction of arrow F1 due to an amount of air that passes through the gap 132 in the distal end wall 120 due to the movement of the piston 130. The dimension of the gap 132 directly corresponds to the resistance force which is generated by the air damper 106. The smaller the size of the gap 132, the larger the resistance force when moving the seatbelt buckle 102 from the retracted position towards the extended position.

In some embodiments, the resistance force applied to counteract movement of the seatbelt buckle 102 away from the air damper 106 is larger when the speed of the movement of the seatbelt buckle 102 from the retracted position towards the extended position is high compared to the resistance force applied to counteract movement of the seatbelt buckle 102 away from the air damper 106 when the speed of the movement of the seatbelt buckle 102 from the retracted position towards the extended position is low. This relationship of speed of movement corresponding to resistance force allows for a user to pull on seatbelt buckle 102 at a low speed when securing the seatbelt tongue plate to the seatbelt buckle 102 for use in the vehicle 1, but will inhibit movement of the seatbelt buckle 102 from the retracted position towards the extended position in the event of a sudden deceleration, such as a collision.

Upon completion of movement of the seatbelt buckle 102 from the retracted position towards the extended position, the force applied to move the seatbelt buckle 102 is stopped and the biasing force of the biasing member 128 biases the piston 130 from the displaced position towards the initial position. As the biasing force of the biasing member 128 biases the piston 130 from the displaced position towards the initial position, the seatbelt buckle 102 is moved from the extended position towards the retracted position in the direction of arrow F2.

In some embodiments, the proximate end wall 122 is open to an environment and/or atmosphere to regulate a pressure within the chamber 126 between the piston 130 and the proximate end wall 122. In some embodiments, the piston 130 forms an airtight seal within the chamber 126 of the housing 116.

Referring to FIG. 5, a seatbelt assembly is generally indicated at 10. The seatbelt assembly 101 includes a seatbelt buckle 102 coupled to an anchor point 104, and a turbine damper 140 disposed between and coupled to the seatbelt buckle 102 and the anchor point 104. The turbine damper 140 is configured to increase a resistance force applied to counteract movement of the seatbelt buckle 102 away from the turbine damper 140 as a speed of the movement of the seatbelt buckle 102 increases. The turbine damper 140 includes a housing 148 and a plurality of blades 142 mounted on rotatable disk 144. The cord portion 112 of the tether 110 is secured to disk 144 via cable anchor 146, and may unwind from disk 144 as the seatbelt buckle 102 is moved from the retracted position towards the extended position. Inside the housing 148 of turbine damper 140, a liquid fluid or gaseous fluid can be used to interact with blades 142 to create a resistance force. A biasing member (not shown) is arranged within the housing 148 and biases the disk 144 to an initial or retracted position. Upon completion of movement of the seatbelt buckle 102 away from the turbine damper 140, the biasing member biases the disk 144 from the displaced position towards the initial position.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A seatbelt assembly comprising:
a seatbelt buckle coupled to an anchor point; and
an air damper disposed between and coupled to the seatbelt buckle and the anchor point, the air damper configured to increase a resistance force applied to counteract movement of the seatbelt buckle away from the air damper as a speed of the movement of the seatbelt buckle increases.

2. The seatbelt assembly of claim 1, wherein the air damper includes a housing, a piston, and a biasing member, the housing includes a side wall, a proximate end wall, and a distal end wall that defines a chamber, the piston disposed within the chamber, the biasing member disposed within the chamber between the distal end wall and the piston, the distal end wall defining a through-bore,
wherein the piston is movable between an initial position and a displaced position, and the biasing member biases the piston towards the initial position, and
wherein the seatbelt buckle is coupled to the air damper by a tether having a buckled end connected to the seatbelt buckle and a damper end connected to the piston.

3. The seatbelt assembly of claim 2, wherein the seatbelt buckle is moveable between a retracted position and an extended position, the piston is moved from the initial position towards the displaced position upon movement of the seatbelt buckle from the retracted position towards the extended position.

4. The seatbelt assembly of claim 3, wherein a portion of the tether extends through the through-bore formed in the distal end wall.

5. The seatbelt assembly of claim 4, wherein a gap is formed between an outer surface of the tether and an inner surface of the through-bore.

6. The seatbelt assembly of claim 5, wherein upon movement of the seatbelt buckle from the retracted position towards the extended position, the piston is moved from the initial position towards the displaced position due to a connection of the seatbelt buckle and the piston by the tether.

7. The seatbelt assembly of claim 6, wherein upon movement of the seatbelt buckle from the retracted position towards the extended position, the piston is moved from the initial position towards the displaced position such that the resistance force is applied to counteract movement of the seatbelt buckle from the retracted position towards the extended position due to an amount of air that passes through the gap in the distal end wall due to the movement of the piston.

8. The seatbelt assembly of claim 7, wherein the resistance force applied to counteract movement of the seatbelt buckle away from the air damper is larger when the speed of the movement of the seatbelt buckle from the retracted position towards the extended position is high compared to the resistance force applied to counteract movement of the seatbelt buckle away from the air damper when the speed of the movement of the seatbelt buckle from the retracted position towards the extended position is low.

9. The seatbelt assembly of claim 8, wherein upon completion of movement of the seatbelt buckle away from the air damper, the biasing member biases the piston from the displaced position towards the initial position.

10. The seatbelt assembly of claim 9, wherein the biasing member is a spring, and wherein the portion of the tether within the chamber extends coaxially with the spring.
